(19) United States
(12) Patent Application Publication
(10) Pub. No.: US 2002/0044721 A1
(43) Pub. Date: Apr. 18, 2002

(54) Mems device having multiple DWDM filters

(76) Inventor: Gary C. Bjorklund, Los Angeles, CA (US)

Correspondence Address: STROOCK & STROOCK & LAVAN LLP, 180 Maiden Line, New York, NY, 10038, US

(21) Appl. No.: 09/877,692

(22) Filed: Jun. 8, 2001

Related U.S. Application Data
(60) Provisional application No. 60/210,852, filed on Jun. 9, 2000.

(51) Int. Cl. G02B 6/35; G02B 6/293; G02B 6/26

(52) U.S. Cl. 385/18; 385/24; 385/47

(57) ABSTRACT

An optical signal processing method and a device which can serve as a signal multiplexer or demultiplexer can be tuned in discrete increments. This device has a movable filter assembly having a number of filters, with each filter having a surface which reflects a particular wavelength of light and passes other wavelengths of light. This defines two wavelength-dependent signal paths. Light reflecting from a reflective surface of the filter passes along one signal path which includes an input waveguide and a first output waveguide. Light transmitted through the filter travels along another signal path which includes the input waveguide and a second output waveguide. The filter can be contained in a trench separating the input and second output waveguides, and can be moved in the trench to alter the optical properties of the two signal paths.

### CROSS-REFERENCE TO RELATED APPLICATION

This application claims priority to Provisional Patent Application No. 60/210,852, filed on Jun.9, 2000.

### FIELD OF THE INVENTION

The present invention is directed to an optical multiplexer/demultiplexer for use with an optical input signal which can consist of several different wavelength division multiplexing (“WDM”) or dense wavelength division multiplexing (“DWDM”) channels. In the case of a demultiplexer, the optical filter can pick off one of these different WDM/DWDM channels, allowing the demultiplexer to be “tuned” in a step-wise manner to extract the desired channel from the multichannel input signal. The optical channel of interest can be separated from the optical input path along an output path, and the remaining channels of the multichannel input signal remain available for use.

### BACKGROUND OF THE INVENTION

Optical fibers play an important part in the transmission of digital data, since such optical fibers can transmit large amounts of data rapidly. Although early optical fibers were used to transmit just a single wavelength of light, the ever-increasing need to increase optical fiber bandwidth has led to optical data transmission systems which transmit multiple wavelengths of light through a single fiber (bandwidth is a term of art and refers generally to the amount of data which a signal path can carry).

The terms “light signal” and “optical signal” as used herein are interchangeable and are intended to be broadly construed and to refer to visible, infrared, ultraviolet light, and the like which fall within the transparency region of the optical fiber.

Among the ways in which optical fiber bandwidth has been increased is through the use of wavelength division multiplexing (“WDM”), along with the related technique of dense wavelength division multiplexing (“DWDM”). WDM and DWDM allow a single optical fiber to carry more than one wavelength of light; each wavelength of light sent through the optical fiber corresponds to a single channel of data. Increasing the number of channels which an optical fiber can support increases bandwidth accordingly; doubling the number of channels doubles the bandwidth. The channels of a WDM or DWDM system are separated in wavelength by some minimum spacing to avoid interference effects which might occur between the signals in adjacent channels. Presently, 100 GHz of optical frequency spacing, corresponding to approximately 0.8 nm spacing between adjacent optical channels is common, although in advanced systems spacings of 50 GHz are being deployed.

Both WDM and DWDM employ multiplexers and demultiplexers combine and separate, respectively, channels from multichannel optical signals. As depicted in FIG. 1, a multiplexer 3 receives several input optical signals A, B, C, D and E, each at an associated wavelength, via inputs 1, 1′, 1″, 1 ′″ and 1″″, respectively. The multiplexer 3 combines optical signals A, B, C, D and E and outputs those signals to optical fiber 5. This way, each of optical signals A, B, C, D and E are simultaneously transmitted through the same optical fiber 5.

Optical fiber 5 leads, either directly or indirectly, via other signal lines, to demultiplexer 7. Demultiplexer 7 takes the combined optical signal from optical fiber 5 and separates that combined optical signal into output signals A′, B′, C′, D′and E′, which are available on outputs 9, 9′, 9″, 9′″ and 9″″, respectively.

It will be appreciated that demultiplexer 7 is the functional opposite of multiplexer 5. The former separates channels from a multichannel signal, and the latter combines separate channels to obtain a multichannel signal.

In prior art tunable filters multiple wavelengths come in on a single fiber, the chosen dropped wavelength emerges on a separate fiber, and the remaining wavelengths leave together on a second output fiber. The filter, being tunable, can be adjusted to pick out any one of the input wavelengths.

Prior art tunable filter devices include tunable Fabry-Perot interferometers, liquid crystal filters, temperature tuned fiber Bragg gratings and unbalanced Mach-Zehnder interferometers.

A common aspect of such known tunable filters is that they tune continuously, not discretely, and hence require some sort of external wavelength calibration.

Size is an ever-present concern in the design, fabrication, and construction of optical components (i.e., devices, circuits, and systems), including multiplexers and demultiplexers. It is clearly desirable to provide smaller optical components so that optical devices, circuits, and systems may be fabricated more densely, consume less power, and operate more rapidly and more efficiently.

There is an ever-increasing need to transmit more and more data over optical signal paths. There is a corresponding need for improved multiplexers and demultiplexers which are small in size, fast in their multiplexing, and reliable in operation.

### SUMMARY OF THE INVENTION

The present invention is directed to an optical signal processing method and a device which can serve as a signal multiplexer or demultiplexer. This device has a movable filter assembly having a number of filters, with each filter having a surface which reflects a particular wavelength of light and passes other wavelengths of light. This defines two wavelength-dependent signal paths. Light reflecting from a reflective surface of the filter passes along one signal path which includes an input waveguide and a first output waveguide. Light transmitted through the filter travels along another signal path which includes the input waveguide and a second output waveguide. The filter can be contained in a trench separating the input and second output waveguides, and can be moved in the trench to alter the optical properties of the two signal paths.

Both multiplexers and demultiplexers can be constructed in accordance with this invention according to the direction in which light travels.

Among the benefits of this invention is that unlike known continuously-tunable filters, this invention provides for discrete filter tuning steps. Tuning is effected stepwise in discrete amounts that correspond exactly to the DWDM wavelength spacings specified by the ITU grid. In contrast to known devices, external wavelength calibration is not required.

A further benefit of this invention is that the tunable filter device is, owing to its manner of construct, readily integrated with other planar waveguide devices such as splitters, taps, couplers and switches. By virtue of this invention high performance photonic integrated circuits (PICs) can be made which incorporate wavelength filtering as one of the functions that they can perform. This is a distinct advantage over known tunable filters such as Fabry-Perot, liquid crystal and temperature tuned fiber Bragg grating devices.

In addition, an optical signal processing device in accordance with the present invention can have a first waveguide separated by a trench from both a second waveguide coaxial with the first waveguide and a third waveguide oriented at an angle to the first waveguide. A filter assembly having reflective filters each reflecting only a particular wavelength of light is movably positioned in the trench, and an actuator connected to the filter assembly moves the assembly so that a particular filter is positioned between the first and the second waveguides. This way, an optical signal propagating in and along the first waveguide which has a wavelength approximately equal to the reflective wavelength of the filter between the first and the second waveguides is reflected from the filter into the third waveguide, whereas an optical signal not having a such a wavelength is transmitted through the filter assembly to the second waveguide.

Another aspect of this invention involves a method of processing a multichannel optical signal by reflecting one channel from a reflector into a first output waveguide and transmitting the other optical channels through the reflector into a second output waveguide.

Still another aspect of this invention relates to limiting an angle of incidence at which the optical signal strikes the reflector's front surface to be not more than approximately 10°. This may be preferable in order to achieve polarization insensitivity.

The invention accordingly comprises the features of construction, combination of elements, and arrangement of parts which will be exemplified in the disclosure herein. The scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIG. 1 is a schematic view of a prior system for transmitting multiple channels of optical data over a single optical fiber;

FIG. 2 is a top plan view of a MEMS device having multiple DWDM filters in accordance with a first embodiment of the present invention;

FIG. 3 is a perspective view of a filter assembly of the device depicted in FIG. 2;

FIG. 4 is a perspective view of the filter assembly shown in FIG. 3;

FIG. 5 is a perspective view of a second embodiment of a filter assembly in accordance with the present invention; and

FIG. 6 is a perspective view of a third embodiment of a filter assembly in accordance with the present invention.

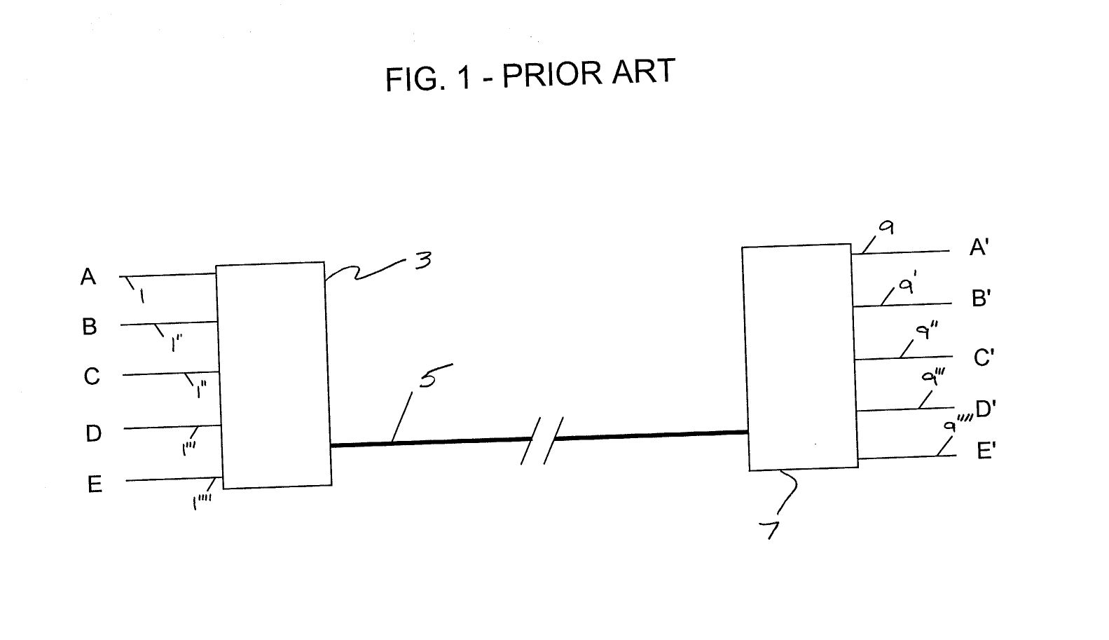

### DETAILED DESCRIPTION OF THE PRESENTLY PREFERRED EMBODIMENTS

The present invention is directed to an optical device having an input waveguide and two output waveguides separated by and disposed around a trench. The input waveguide and a first output waveguide have respective optical paths defined by their respective cores, and those optical paths (and cores) are aligned or coaxial with each other. Typical channel waveguide cross-sectional dimensions are 7 μm by 7 μm. The waveguides are separated by the trench, the trench having a medium provided therein that has a refractive index different from that of the waveguides. A movable filter assembly is disposed in the trench in such a way that the filter assembly can be shifted into and within the optical path (i.e., of light leaving the input waveguide). The filter assembly is constructed so that different portions of the filter will reflect different wavelengths of light. Consequently, the position of the filter assembly in the trench will determine the wavelength of light passing from the input waveguide to the first output or dropped channel waveguide, as well as the wavelengths of light which are transmitted through the filter assembly to the second output or through channel waveguide.

Moreover, the input waveguide and through channel waveguide are separated by a distance insufficient to significantly affect the transmission characteristics of an optical signal propagating from the input waveguide, through and across the trench and to the through channel waveguide, even though the optical signal experiences different refractive indices as it propagates from the input waveguide through the filter (and trench) to the through channel waveguide. Thus, even though the optical signal experiences some diffraction as it propagates across the trench and may pass through the filter, the distance over which the optical signal must pass between the waveguides is small enough so as to not to significantly affect the optical transmission characteristics of that signal. Excess loss will be less than 10 dB.

In like manner the input waveguide and the dropped channel waveguide are arranged generally on the same side of the trench such that an optical signal passing from the input waveguide to the dropped channel waveguide does not completely traverse the trench but instead, reflects off the surface of a filter. Once again, even though the optical signal experiences different indices of refraction for the waveguide and medium provided in the trench, the optical signal propagates over a distance too small to adversely affect the optical transmission characteristics of that signal.

That is, while the trench is large enough to allow for the finite thickness of the filter assembly to be placed inside the trench, the trench should also be as small as possible to minimize the light diffraction in the trench gap.

Referring now to the drawings in detail, and with initial reference to FIG. 2, a demultiplexer 2 constructed in accordance with an embodiment of the present invention is there depicted. The waveguide construction described below is provided as an illustrative, non-limiting example of an embodiment of the present invention; other waveguide geometries and configurations are contemplated by and fall within the scope and spirit of the present invention.

The demultiplexer 2 includes an input waveguide 11, a through channel waveguide 13, and a dropped channel waveguide 15 arranged around trench 17 such that input waveguide 11 and through channel waveguide 13 are separated by the trench 17. Input waveguide 11 and the through and dropped channel waveguides 13 and 15 can be constructed in accordance with the general knowledge in the art. By way of non-limiting example, the waveguides 11, 13 and 15 can be constructed using semiconductor fabrication techniques such as reactive ion etching and methods known to those skilled in the art, and thus need not be described in detail here. At present it is thought that a buried waveguide configuration is preferable. Further, waveguides 11, 13 and 15 could be formed from a wide variety of materials chosen to provide the desired optical properties. By way of further non-limiting example, it is believed preferable to construct the demultiplexer 2 of the present invention using a waveguide structure that supports large optical mode sizes that minimize the diffraction losses crossing the trench. Preferred examples are silica based. For example, germanium-doped silica would be used for the channel waveguides and thermal SiO₂ or boron phosphide-doped silica glass could be used for the cladding layers.

As explained in greater detail below, an optical signal 31 propagating in and along input waveguide 11 is a multichannel signal having a plurality of wavelengths λ₁, λ₂, λ₃. . . λₙ (n is an integer). The optical signal 35 propagating in and along dropped channel waveguide 15 is a single-wavelength signal corresponding, for the purpose of illustration only, to wavelength λ₂ (other wavelengths also could be dropped). All of the other channels (i.e., wavelengths) of the optical signal 31 propagate across trench 17 through filter assembly 41 into the through channel waveguide 13 as signal 33, which consists of wavelengths λ₁, λ₃ . . . λₙ (n is an integer). Changing which channel (i.e., wavelength) is directed through the dropped channel waveguide 15 will change which channels (i.e., wavelengths) of optical signals are transmitted along the through channel waveguide 13. As used herein, the terms “channel” and “wavelength” are generally interchangeable.

With continued reference to FIG. 2, it will be noted that the optical signal 31 traveling in and along input waveguide 11 leaves the waveguide 11 through output facet 27, (the term “facet” refers to an end of a waveguide) and enters trench 17. The optical signal 31 continues onward across the trench and strikes filter assembly 41.

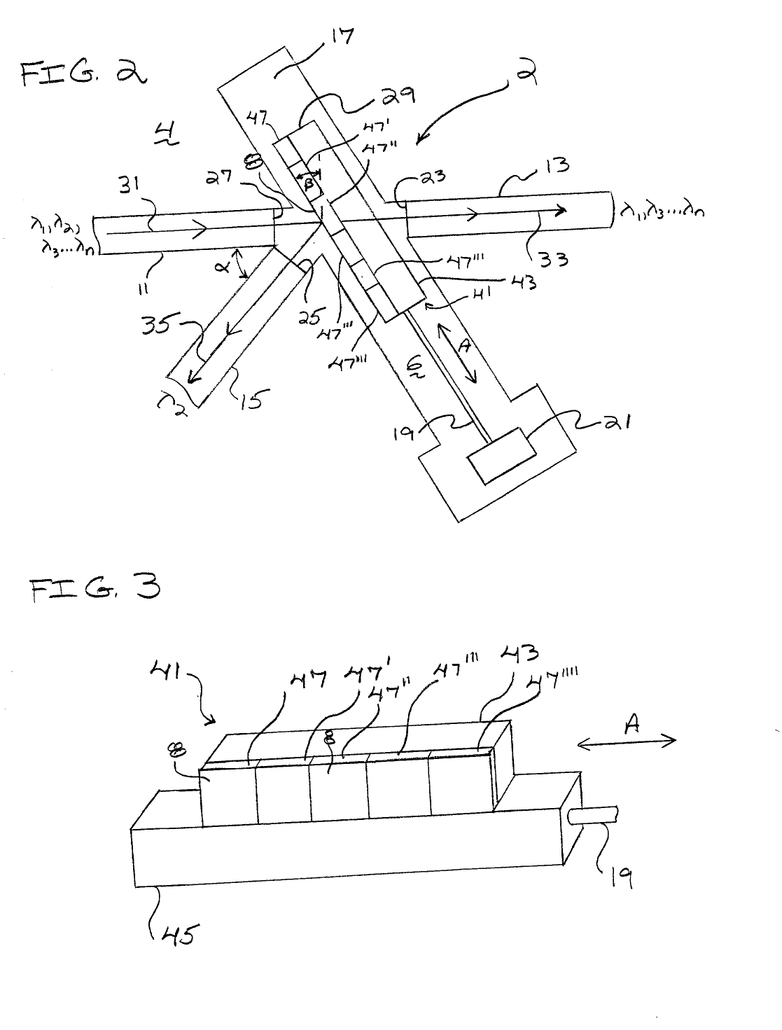

As depicted in FIGS. 2 and 3, filter assembly 41 has a number of filters 47, 47′, 47″, 47′″, 47″″ mounted on support 45. Each filter 47, 47′, 47″, 47′″, 47″″ corresponds to a particular signal channel; that is, each filter reflects a different wavelength of light λ₁, λ₂, λ₃ . . . λₙ A back support 43 is positioned on support 45 behind and in abutting contact with filters 47, 47′, 47″, 47′″ and 47″″. Preferably, the filters 47, 47′, 47″, 47′″ and 47″″ and the back support 43 are joined to both each other and the support 45 by a suitable bonding technique such as UV adhesive. Thus, the back support 43 stiffens and strengthens filter assembly 41.

It is thought to be preferable to use vacuum deposited dielectric stacks as the filter structure, this being a generally well-known way of producing high-resolution filters. Such filters are able to resolve the DWDM channels. Deposition of the films could be made directly onto the support and be patterned lithographically.

Although as depicted in FIG. 2, filters 47-47″″ are directly adjacent to one another, those filters need not be directly next to each other. Adjacent filters could be separated by islands of non-reflective material (not shown). Alternatively, the filters could be separated by sensor regions, which would indicate when those sensor regions are struck by the input optical signal 31. Such sensors could thereby help monitor the position of the filter assembly 41 along trench 17.

Support 45 is preferably made from a light yet stiff material such as silicon, polymers, metallic or dielectric materials commonly used in MEMS technology. Such a low-mass, rigid support 45 can be caused to move quickly in response to an electrical signal, for example, between the position depicted in FIG. 2, in which the optical signal 31 output from the input waveguide 11 strikes filter 47″ so that a portion 35 of that optical signal 31 is reflected from the front surface 8 of filter 47″ to the dropped channel waveguide 15 and the remainder of the optical signal 31 travels as optical signal 33 through filter 47″ and in and along the through channel waveguide 13, and other positions (not shown) in which other filters 47, 47′, 47′″, 47″″ lie in the path of the optical signal 31 or even shift the filter assembly 41 so that no filter lies in the path of optical signal 31.

Back support 43 is preferably transparent to all wavelengths, meaning that an optical signal having one or a plurality of wavelengths can pass therethrough without attenuation. As shown in FIG. 2, optical signal 33 emerges from back support 43, and passes through input facet 23 into through channel waveguide 13.

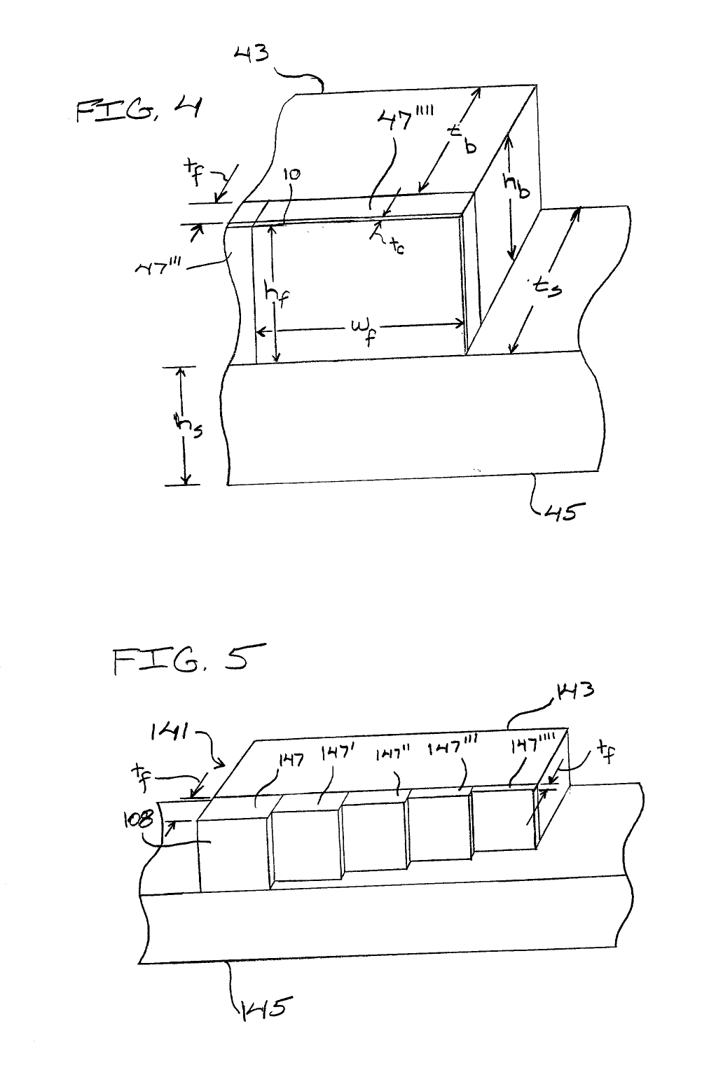

With reference now to FIG. 4, filter 47″″ is depicted in detail. It should be noted that the following detailed description of filter 47″″ is illustrative of each filter of the filter assembly 41. The detailed discussion of filter 47″″ thus applies equally to each filter of the filter assembly 41, unless expressly stated to the contrary. As shown in FIG. 4, filter 47″″ has a height h_{f}, a width w_{f} and a thickness t_{f} and is mounted upon support 45, which has a thickness tₛ, and a height hₛ. Filter 47″″ is composed of a stack of dielectric thin films 10 having an overall thickness t_{c}. The back support 43 has a thickness t_{b}, and a height h_{b} which can be the same as h_{f}. By way of non-limiting example, these dimensions could be selected as follows: h_{f}=10-25 μm, w_{f}=15-35 μm, t_{f}=0.5-5 μm, tₛ=8-15 μm, hₛ=50-500 μm, t_{c}=0.1-2 μm, t_{b}=3-7 μm, and h_{b}=10-25 μm.

By way of non-limiting example, since the diameter of the beam of the input signal 31 in the trench 17 is approximately 10 μm, the minimum height h_{f} and width w_{f} of each filter 47, 47′, 47″, 47′″, 47″″ is preferably approximately 20 μm. This way, optical signal 31 will be fully-intercepted by each filter 47, 47′, 47″, 47′″, 47″″.

More particularly, a tunable filter in accordance with this invention could be constructed such that each filter is approximately 20 μm wide and approximately 20 μm high. The entire filter assembly could be about 200 μm wide and approximately 40 μm high.

Furthermore, the first and the second waveguides could be separated from each other by a distance of not more than approximately 8-40 μm, and more preferably, not more than approximately 12-20 μm.

Given the foregoing filter dimensions, and for a linear displacement of the filter assembly 41 of approximately 200 μm, the filter assembly 41 may be constructed with ten filters for filtering ten DWDM channels (for convenience, not all ten filters have been depicted). It is thought to be preferable to minimize the size of the filter assembly 41 in order to reduce the electrical power required to move the filter assembly 41 along the optical path, and improve the speed with which the demultiplexer 2 can be switched between channels.

The major effect of the filter/back support thickness is a lateral translation of the transmitted beam, although the beam will still propagate parallel to its original direction. This translation can be compensated for by laterally displacing waveguide 13.

Filters 47, 47′, 47″, 47′″ and 47″″ have differing optical properties such that different wavelength optical signals reflect therefrom, and other, non-reflected wavelengths of a multi-wavelength optical signal can pass therethrough without substantial attenuation. The reflective material 10 coating each filter 47, 47′, 47″, 47′″, 47″″ has a thickness or composition selected such that a particular wavelength optical signal can be reflected therefrom, and so each of filters 47, 47′, 47″, 47′″ and 47″″ reflects a particular wavelength of the optical signal 31 or channel of data. Accordingly, the position of filter assembly 41 will determine the optical signal channel which will be reflected by the reflective material 10.

As noted above, the composition and thickness of the reflective material 10 applied to the face 8 of each filter 47-47″″ will determine the wavelength of light that will be reflected.

Each of filters 47, 47′, 47″, 47′″, 47″″ could be made to reflect a particular wavelength of light λ₁, λ₂, λ₃ . . . λₙ without attenuation and transmit the remaining wavelengths of light unimpeded using by forming a multilayer dielectric stack. This can be accomplished using techniques which can be employed to fabricate thin-film dielectric interference filters. As this aspect of the fabrication technology is itself known, no further explanation of thin film fabrication techniques is needed.

Alternatively, each of filters 47, 47′, 47″, 47′″, 47′″ could be made to reflect a particular wavelength of light λ₁, λ₂, λ₃ . . . λₙ by using filters made from different materials. Such filters would not have to be coated with a layer of reflective material. By way of non-limiting example, filters 47, 47′, 47″, 47′″, 47″″ could be made from Si base material, with each filter being doped with progressively more dopant, thereby changing the optical properties of the Si so that the Si is reflective (or alternatively, transmissive) to different wavelengths of light.

Referring back to FIG. 2, the dropped channel optical signal 35 propagates in and along dropped channel waveguide 15, and can be directed to other devices such as an amplifier or opto-electrical converter (not shown) for further signal processing.

With continued reference to FIG. 2, those channels of optical signal 31 which are not reflected by the filter assembly 41 into dropped channel waveguide 15 (signal 35) pass as signal 33 through input facet 23 into the through channel waveguide 13. Optical signal 33 propagates in and along the through channel waveguide 13 for further processing to other downstream devices such as additional demultiplexers (not shown), or the signal can be discarded.

Filter assembly 41 is contained in trench 17 formed in substrate 4 and is joined to actuator 21 by member 19. As shown in FIG. 2, actuator 21 can be driven to cause filter assembly 41 to reciprocate in the direction of arrow “A”. By positioning a predetermined one of filters 47, 47′, 47″, 47′″ and 47′″ in the path of optical signal 31, only the wavelength to which the predetermined filter is “tuned” will be reflected as beam 35 into and propagate in and along dropped channel waveguide 15; the remaining wavelengths pass through the filter as beam 33 and in and along through channel waveguide 13.

It also may be desirable to have the input optical signal 31 pass directly and without change into through channel waveguide 13. One way in which that can be accomplished is by moving filter assembly 41 by a distance such that the filter assembly 41 does not lie in the optical path between input waveguide 11 and dropped channel waveguide 13.

Similarly, if it is desired to have all of the channels (i.e., wavelengths) of input optical signal 31 enter dropped channel waveguide 15, one of filters 47, 47′, 47″, 47′″ or 47″″ or even a separate filter (not shown) could be coated with a material which reflects all of the wavelengths in the input optical signal 31. When such a mirrored filter is moved into the path of the input optical signal 31, the optical signal 31 will be completely reflected into the dropped channel waveguide 15.

With continued reference to FIG. 2, the optical paths defined by the respective cores of input waveguide 11 and through channel waveguide 13 are preferably aligned or coaxial with each other. This maximizes the amount of light transferred from input waveguide 11 to through channel waveguide 13.

The dropped channel waveguide 15 defines an optical path that is oriented with respect to the input waveguide 11 optical path at a predetermined angle α that is preferably between approximately 5°-80°, and more preferably, the angle between the waveguides can be 16°.

Optionally, the facet 27 of the input waveguide 11 through which the optical signal 31 exits the input waveguide 11 to enter the trench 17, and the facets 23, 25 of the through channel and dropped channel waveguides 13, 15, respectively, can be angled with respect to the corresponding waveguide's optical path (not shown). By way of non-limiting example, the angle of each of the facets could preferably be angled by between approximately 6° and 10° relative to the optical axis of the associated waveguide.

To improve optical properties, each facet is preferably provided with an antireflective (AR) coating. It is presently thought that the AR coating could be on the order of 0.5 μm thick. Other relevant aspects of AR coating will be understood by those skilled in the art.

Trench 17 is defined in a substrate 4 (see, e.g., FIG. 2) that separates the input waveguide 11 and through channel waveguide 13, and around which the waveguides are arranged. The trench 17 is filled, partly or completely, with an optically transparent medium 6 such as, for example, air, having an associated index of refraction n. For air, the index of refraction is approximately equal to 1.00.

By way of non-limiting example, the trench 17 could have a width wt of approximately 8-40 μm wide, and more preferably, 12-20 μm wide.

With continued reference to FIG. 2, the actuator 21 causes the filter assembly 41 to move reciprocally in the direction of arrow A. If desired, the actuator 21 could cause the filter assembly to move in other directions as well, so long as that movement provides the ability to switch the particular filter 47, 47′, 47″, 47′″, 47″″ which is in the optical path, and provided the actuator 21, member 19, trench 17 and other components are suitably arranged. By way of non-limiting example, the filter assembly could be moved in a direction perpendicular to the plane of the drawing.

Movement of the filter assembly 41 by the actuator 21 may be in response to a control signal input to the actuator 21 via an input (not shown). That control signal may be electrical, optical, mechanical, or virtually any other signal capable of causing the actuator 21 to respond.

Various embodiments of the actuator 21 are contemplated by the present invention including, by way of non-limiting example, electrothermal, electrostatic, and piezoelectric devices.

With reference now to FIG. 5, a second embodiment of the present invention is depicted, wherein filter assembly 141 is constructed such that the individual filters 147, 147′, 147″, 147′″ and 147″″ mounted upon support 145 all have different thicknesses t_{f}. For filters constructed of the same or optically equivalent material, the wavelengths which are reflected and which can pass through any of these filters 147, 147′, 147″, 147′″ and 147″″ are determined by the filter's thickness. Again, such filters are preferably constructed using thin-film dielectric interference filters, and those skilled in the art would understand how to prepare filters having the desired optical properties. Thus, instead of changing the material properties of the individual filters, or applying a coating thereto, or making the filters from different materials, to change the optical channels which each filter can reflect/pass, the filters 147, 147′, 147″, 147′″ and 147″″ are shaped so that their thicknesses t_{f} determine the optical wavelength that can be transmitted.

It also will be appreciated that the filters 147, 147′, 147″, 147′″ and 147″″ could be reversed to face back support 143. In that case, back support 143 could be provided with a stepped surface matching the faces of filters 147, 147′, 147″, 147′″ and 147″″, so that the stepped interface is located in between the back support 143 and the filters 147, 147′, 147″, 147′″ and 147″″. Since back support 143 is optically transparent, the fact that the back support's thickness t_{b} varies should not change the wavelength of the optical signal which can pass through the corresponding filter. In this arrangement, a reflective coating (not shown) or the use of differing filter materials for each filter 147, 147′, 147″, 147′″, 147″″ would be required.

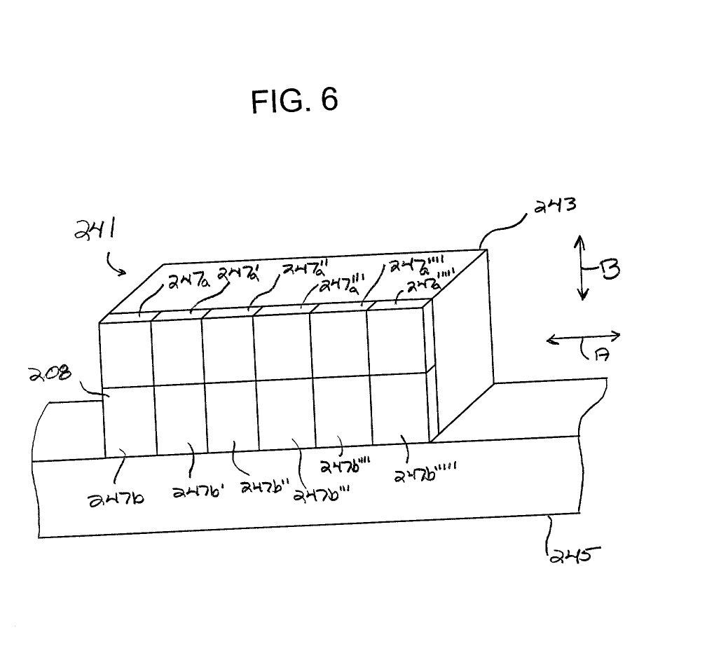

A third embodiment of this invention, depicted in FIG. 6, contemplates a filter assembly 241 capable of two-dimensional movement. Filter assembly 241 includes back support 243, two rows of filters 247a-247a′″″ and 247b-247b′″″, and support 245. The filter assembly 241 can be moved in the directions of both arrows A and B by a suitable actuator(s) (not shown). Consequently, the depth of the trench (not shown) in which the filter assembly 241 moves may have to be correspondingly modified. It will be appreciated that this arrangement can provide for a more compact and faster-operating device.

It also will be understood from this disclosure that by providing additional rows of filters (not shown), even more channels (wavelengths) of optical signals can be discriminated.

It should be understood that a 2×2 filter would be able to perform both an add and a drop of signals.

Those skilled in the art will in view of the foregoing disclosure understand that the present also encompasses filters which transmit the selected wavelength and reflect all of the other wavelengths. In such a filter the functions of the two output waveguides 13, 15 would be interchanged.

Those skilled in the art will after reading the foregoing understand that although the disclosed embodiments are described as a demultiplexer 2, such embodiments are equally suited for use in a multiplexer through reversal of the direction of propagation of the optical signals 31, 33, 35. By way of non-limiting example, and with reference to FIG. 2, a single channel of optical information 35 propagating along waveguide 15 toward filter assembly 41 could be combined with an optical signal 33 propagating along waveguide 13 toward filter assembly 41. Optical signal 33 passes through back support 43 and filter 47″ of filter assembly 41, while optical signal 35 reflects off the front surface 8 of filter 47″. Optical signals 33 and 35 combine and propagate together along waveguide 11 as multichannel optical signal 31.

To overcome the undesirable effects of the differing refractive indices of the different optical components used, the present invention controls the distance between the output facet 27 of the input waveguide 11 and the input facets 23, 25, of the dropped channel and through channel waveguides 13, 15 so that the optical signals 31, 33 and 35 propagate over too short a distance for the difference in refractive indices to introduce any significant change in the optical signals' characteristics. Thus, even though the input optical signal 31 completely traverses the trench 17 (from input waveguide 11 to through channel waveguide 13), or partly traverses the trench 17 (from input waveguide 11 to dropped channel waveguide 15), the output optical signals 33 and 35 do not experience any significant adverse affect due to the difference in the medium 6 and waveguide respective refractive indices.

In order to achieve polarization insensitivity, it may be preferable to reduce the angle of incidence βdepicted in FIG. 2 of optical signal beam 31 onto the filters' front surfaces 8 to be not more than approximately 10°. It will be understood that the angle of incidence β refers to an amount by which the incoming optical signal beam 31 deviates from the perpendicular to the plane of the front surface. Thus, a perpendicular beam has an angle of incidence of 0°.

This invention can be manufactured using known fabrication techniques. By way of non-limiting example, these small spatially discreet DWDM filters could be produced using photoresist patterning techniques such as etching through masking or lift off techniques.

The present invention will work with both weakly-confined waveguides and strongly-confined waveguides. Presently, weakly-confined waveguides are thought to be preferred.

Again, throughout the foregoing disclosure, the dimensions described are offered by way of example and not limitation. It should be understood that this invention is not intended to be limited to the angles, materials, shapes or sizes portrayed herein, save to the extent that such angles, materials, shapes or sizes are so limited by the express language of the claims.

While the present invention as depicted in FIG. 2 has a single input optical path 11 and two output optical paths 13, 15, it will be understood that additional input and output optical paths (not shown) could be included. By way of example, a second input waveguide and third and fourth output waveguides could be provided at a different position.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. An optical signal processing device, comprising:
a first waveguide defining a first waveguide optical path;
a second waveguide defining a second waveguide optical path generally coaxial with the first waveguide optical path;
a third waveguide defining a third waveguide optical path that is oriented with respect to the first waveguide optical path at a predetermined angle;
the first, second and third waveguides being arranged around a trench that separates the first waveguide and the second waveguide;
a filter assembly disposed in the trench and having a plurality of filters, each of which has an associated reflective wavelength such that the filter reflects that associated reflective wavelength; and
an actuator connected to the filter assembly for causing the filter assembly to move to position one of the filters between the first and the second waveguides, so that a first optical path for an optical signal having the associated reflective wavelength includes the first waveguide optical path and the third waveguide optical path, and a second optical path for an optical signal not having the associated reflective wavelength includes the first waveguide optical path and the second waveguide optical path.

2. An optical signal processing device according to claim 1, wherein the one of the filters has a reflective surface which reflects light having the associated reflective wavelength and a transparent body through which light having a wavelength other than the associated reflective wavelength can pass.

3. An optical signal processing device according to claim 1, wherein the signal processing device is a multiplexer.

4. An optical signal processing device according to claim 1, wherein the signal processing device is a demultiplexer.

5. An optical signal processing device according to claim 1, wherein an optical signal propagating along the first waveguide comprises a plurality of channel signals, each said channel signal having a wavelength.

6. An optical signal processing device according to claim 5, wherein each channel signal has a unique wavelength.

7. An optical signal processing device according to claim 1, wherein the filters are arranged in a one-dimensional array.

8. An optical signal processing device according to claim 1, wherein the filters are arranged in a two-dimensional array.

9. An optical signal processing device according to claim 1, wherein the filters all have substantially a same thickness.

10. An optical signal processing device according to claim 1, wherein the filters all have different associated reflective wavelengths.

11. An optical signal processing device according to claim 1, further comprising:
a medium disposed in the trench and having an associated index of refraction; and
wherein an associated index of refraction for each of the first, second and third waveguides are approximately the same and are different than the associated index of refraction of the medium, the first and second waveguides and the first and third waveguides being separated from each other by a distance over which an optical signal passing therethrough is not affected by the different indices of refraction of the waveguides and the medium.

12. An optical signal processing device according to claim 5, wherein an optical signal propagating along the first waveguide strikes one of the filters in the filter assembly, so that one of the channel signals is reflected from the filter through the third waveguide and the other channel signals of the optical signal propagate through the second waveguide.

13. An optical signal processing device according to claim 1, wherein an index of refraction of the first, second and third waveguides is approximately the same.

14. An optical signal processing device according to claim 1, wherein the first waveguide has a facet through which an optical signal exits the first waveguide to enter the trench, the second waveguide has a facet through which an optical signal transmitted through the one of the filters between the first and the second waveguides across the trench enters the second waveguide, and the third waveguide has a facet through which an optical signal reflected by the reflective surface and leaving the trench enters the third waveguide.

15. An optical signal processing device according to claim 14, wherein at least one of the first, second and third waveguide facets is angled with respect to the corresponding waveguide's optical path.

16. An optical signal processing device, comprising:
a first waveguide defining a first waveguide optical path;
a second waveguide defining a second waveguide optical path generally coaxial with the first waveguide optical path;
a third waveguide defining a third waveguide optical path that is oriented with respect to the first waveguide optical path at a predetermined angle;
the first, second and third waveguides being arranged around a trench that separates the first waveguide and the second waveguide;
a filter assembly disposed in the trench and having a plurality of filters each of which has an associated reflective wavelength such that the filter reflects that associated reflective wavelength; and
an actuator connected to the filter assembly for causing the filter assembly to move to position one of the filters between the first and the second waveguides, so that an optical signal propagating along the first waveguide and having a wavelength approximately equal to the reflective wavelength of the one of the filters is reflected by the one of the filters into the third waveguide, and an optical signal propagating along the first waveguide having a wavelength not approximately equal to the reflective wavelength of the one of the filters passes through the one of the filters to the second waveguide.

17. A method of processing an optical signal having a plurality of channels, each channel having a wavelength associated therewith, comprising the steps of:
providing a first optical waveguide for guiding the optical signal;
providing a plurality of reflectors, each having an associated reflective wavelength;
providing a first output waveguide; and
providing a second output waveguide, positioning a selected reflector relative to the first optical waveguide such that a selected channel of the optical signal having the associated wavelength is reflected by the reflector into the first output waveguide, and wherein channels not having the associated reflective wavelength pass through the reflector to the second output waveguide.

18. A method according to claim 17, further comprising the step of selecting the channel of the optical signal which is reflected into the first waveguide according to that channels' associated wavelength

19. A method according to claim 18, wherein the reflecting of the channel of the optical signal having the associated reflective wavelength into the first output waveguide comprises the steps of:
providing a filter assembly comprising at least one reflector, the reflector reflecting light having a particular wavelength and transmitting light not having the particular wavelength; and
positioning the filter in the optical path so that the optical signal strikes the reflector.

20. A method of processing an optical signal having a plurality of channels, each channel having a wavelength associated therewith, comprising the steps of
guiding the optical signal along a first optical waveguide defining a first optical path to strike a reflector, the reflector having an associated reflective wavelength;
reflecting a channel of the optical signal having the associated reflective wavelength into a first optical output path defined by a first output waveguide; and
transmitting channels of the optical signal not having the associated reflective wavelength through the reflector into a second optical output path defined by a second output waveguide.
